(19) United States
(12) Patent Application Publication
(10) Pub. No.: US 2005/0190046 A1
(43) Pub. Date: Sep. 1, 2005

(54) Geared bicycle wheel display disk

(76) Inventors: Scott James Young, Denver, CO (US); Mark Eugene Young, New York, NY (US); Todd Harrison Hutcheson, New York, NY (US)

Correspondence Address: Scott Young, 3300 Osage Street, Denver, CO, 80211, US

(21) Appl. No.: 11/066,421

(22) Filed: Feb. 25, 2005

Related U.S. Application Data
(60) Provisional application No. 60/547,469, filed on Feb. 25, 2004.
(60) Provisional application No. 60/547,472, filed on Feb. 25, 2004.
(60) Provisional application No. 60/547,467, filed on Feb. 25, 2004.

(51) Int. Cl. B62J 3/00

(52) U.S. Cl. 340/432

(57) ABSTRACT

The present invention describes a internally geared display bicycle wheel covers that rotate upon a gear cluster in relation to the rotation of the bicycle wheel. The invention consists of twin disk assemblies mounted to both sides of a conventional bicycle wheel and inturn to the front and rear of a bicycle frame. The disk assemblies are manufactured of lightweight inexpensive material that is formed to the convex shape of the outer surface of a bicycle wheel and includes an internal gear mechanism made of a high density, self lubricating plastic. Gear ratios may be changed to achieve a desired rotation of the outer display disk or geared as such to hold the disk in an upright position at all times whether the bicycle is in motion or in repose.

### CROSS REFERENCE TO RELATED APPLICATIONS

Reference to: U.S. Provisional Patent Application 60/547,469
U.S. Provisional Patent Application 60/547,472
U.S. Provisional Patent Application 60/547,467

### STATEMENT OF FEDERALLY SPONSORED RESEARCH/DEVELOPMENT

“Not Applicable”

### SEQUENCE LISTING

“Not Applicable”

### BACKGROUND OF INVENTION

The present invention relates generally to a pair of bicycle wheel covers, and more particularly, to a pair of lightweight internally geared display bicycle wheel covers that rotate upon a gear cluster in relation to the rotation of the bicycle wheel.

Bicycles are a popular mode of transportation and recreation. As their main means of use is out of doors this creates a vast commercial opportunity as an advertising display medium. Advertising on bicycles is not a new concept nor are wheel covers.

Wheel covers or “shrouds” on bicycles have been used for aerodynamics, safety and aesthetic purposes. The problem arriving with this type of display is that it is not readable as the bicycle is in motion when imprinted with a message. Additionally, the display is inevitably not upright after the bicycle has been parked.

The use of a counterweight has been used on motor vehicles but is ineffective in many ways regarding a bicycle application: a bicycle requires balance of the wheels, frame and rider and the counterweight would fight against this and could result in a very dangerous situation; bicycles need to be light weight; spacing tolerances on the rear wheel of a bicycle rim are at a minimum due to the rear sprocket, gears, or break and could not accommodate a counterweight; a counterweighted wheel cover does not remain absolutely still during riding would tend to oscillate at braking; counterweights are inherently unstable.

Importantly, U.S. Pat. No. 4,729,604 (Dietz) discloses a “wheel shroud” designed as a single plastic cover with means to access the air valve of a bicycle wheel.

U.S. Pat. No. 4,418,962 (Schaffer) describes a ridged spoked wheel cover, much like the above described patent, primarily for decorative purposes.

U.S. Pat. No. 4,712,838 (Berg, et al.), as well as U.S. Pat. No. 4,969,693 (Molson) both disclose a non ridged cover attached to a bicycle wheel. U.S. Pat. No. 3,602,550 indicates a decorative wheel cover which includes an applique type of design, as the above referenced patents, it rotates with the wheel.

A bicycle wheel cover used for safety against the spoked region of a bicycle wheel is disclosed in U.S. Pat. No. 4,202,582 (Seltman).

A bicycle wheel cover disclosed in U.S. Pat. No. 5,131,727 (Johnson) is used for aerodynamic purposes and is also a single cover.

Disclosed within U.S. Pat. No. 6,568,110 (Lee, et al.) is described various uses for a non rotating display using a counterweight and a friction prevention unit including, but not limited to, a vehicle.

U.S. Pat. 5,490,342 and U.S. Patent both describe a Non-rotating wheel cover for a vehicle and are both disclosed for use on automobiles and other motorized vehicles using a counter weight. As do U.S. Pat. No. 5,659,989, U.S. Pat. No. 5,588,715, U.S. Pat. No. 4,678,239 (Matsushita) and U.S. Pat. No. 6,120,104 (Okamoto).

Other Prior art disclosing non-rotating vehicle wheel displays Include: U.S. Pat. No. 4,280,293 (Kovalenko), U.S. Pat. No. 6,164,678 (Fryer), U.S. Pat. No. 5,957,542 (Boothe, et al.) and U.S. Pat. No. 1,478,475 (Jago, et al.)

It is therefore apparent that the present invention discloses a pair of display wheel cover assemblies that, when attached to a bicycle wheel and in turn to a bicycle, forward or rear, create an absolute motionless upright display surface unlike any of the above described inventions.

### SUMMARY OF INVENTION

The present invention relates generally to a pair of bicycle wheel covers, and more particularly, to a pair of lightweight internally geared display bicycle wheel covers that rotate upon a gear cluster in relation to the rotation of the bicycle wheel either maintain an absolute upright position, rotating slower than the rotation of the bicycle wheel, or rotating in the opposite direction of the bicycle wheel.

Control of the outer display disks is achieved through the use of an internally mounted gear cluster utilizing a planetary gear type of system. Various gear ratios may be used to achieve the desired effect.

To maintain longevity, minimal thickness, correct spacing and centering of the two disk per wheel side assembly, a lightweight, plastic four geared assemblage mounted to a stamped aluminum support member is utilized utilized. This assemblage is inturn mounted to the base disk closest to the spokes and the reverse side of the display disk. A large diameter hole in the middle of each display disk, where the gear mechanism resides, accommodates the passing through of the bicycle's wheel hub and skewer assembly.

Display disks are printed as to display advertising or graphic images on the outer face. Display disks range in diameter to accommodate various wheel sizes from small children's bicycles to adult sized bicycles, so as to completely cover the spoke area of the wheel to the inner rim edge. The outward facing display disk may also be cut into various shapes depicting products or images and rotate with the gears as would the curricular disk.

A notch is introduced into the outer edge of each backing disk to accommodate a bicycle automobile roof mounting system or a antitheft device opposite of which a hole is located to facilitate adding air to the air valve.

### DESCRIPTION OF THE SEVERAL VIEWS OF THE DRAWINGS

FIG. 1. is a front view of the revers gear assemblage mounted to it's support structure

FIG. 2. is a side view of the gear assemblage.

FIG. 3. is a front view of display disk as mounted to typical bicycle spoke and wheel assembly.

FIG. 4. is a front view of the base disk with the display disk removed showing placement of gear assemblage, mounting holes, lock and carrier notch and air valve access hole.

FIG. 5. is a detailed section view of display disk as mounted to typical bicycle spoke and wheel assembly showing location of gear assemblage.

FIG. 6. is a detailed section view of display disk showing mounting attachment.

FIG. 7. is a detailed view of the gear assemblage in relation to the base disk and the outer display disk.

FIG. 8. is an elevation view of a typical bicycle showing front and rear application of bicycle wheel display disks.

### DETAILED DESCRIPTION OF THE INVENTION

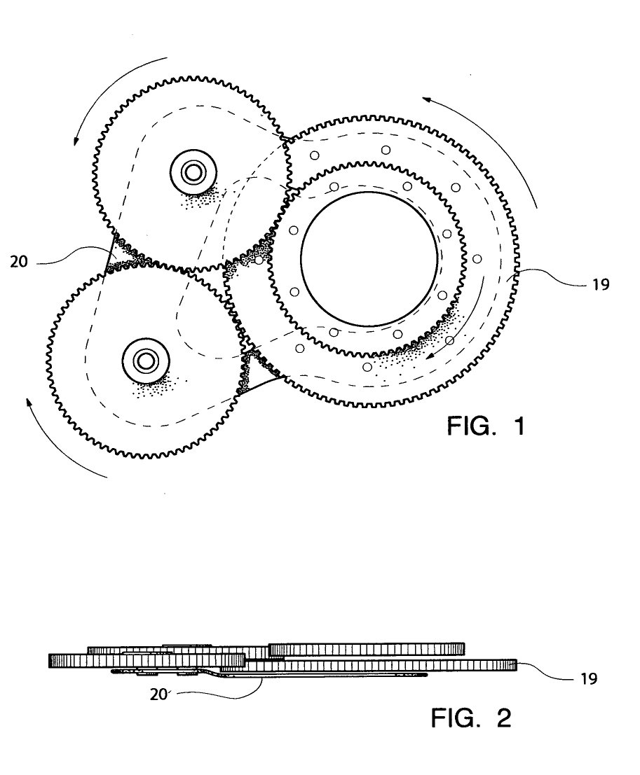

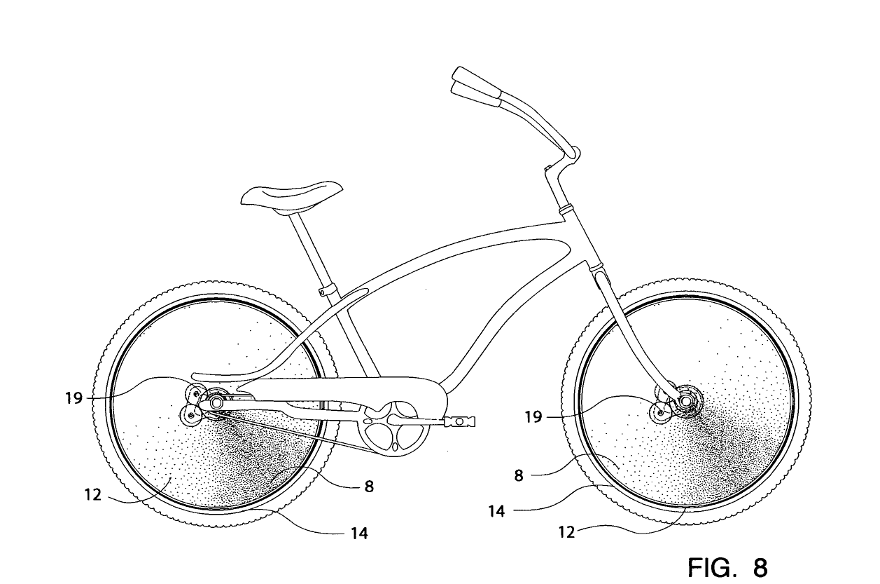

Referring now to the drawings, the preferred embodiment of the invention is shown in FIGS. 1 through 8.

Turning to FIG. 1 we see item 19, the reverse gear cluster as mounted to item 20, a stamped aluminum support plate. Each gear moves in the opposing direct as the bicycle wheel rotates and finally coming back to the center rotating the opposite direction. This outer gear is directly attached to the reverse side of the outer display disk causing it to rotate as well. Gears ratios are vary to create desired effect.

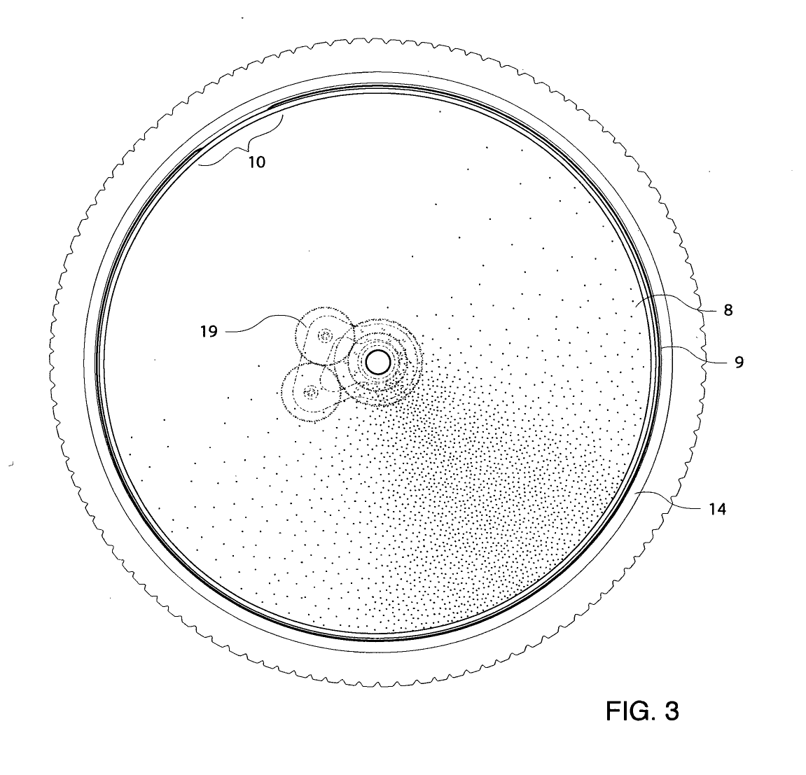

Moving to FIG. 3, we see the invention mounted to a bicycle wheel and tire assembly designated as 14. By keeping the outer surface clean of these components the function of the base disk, 9, becomes unseen.

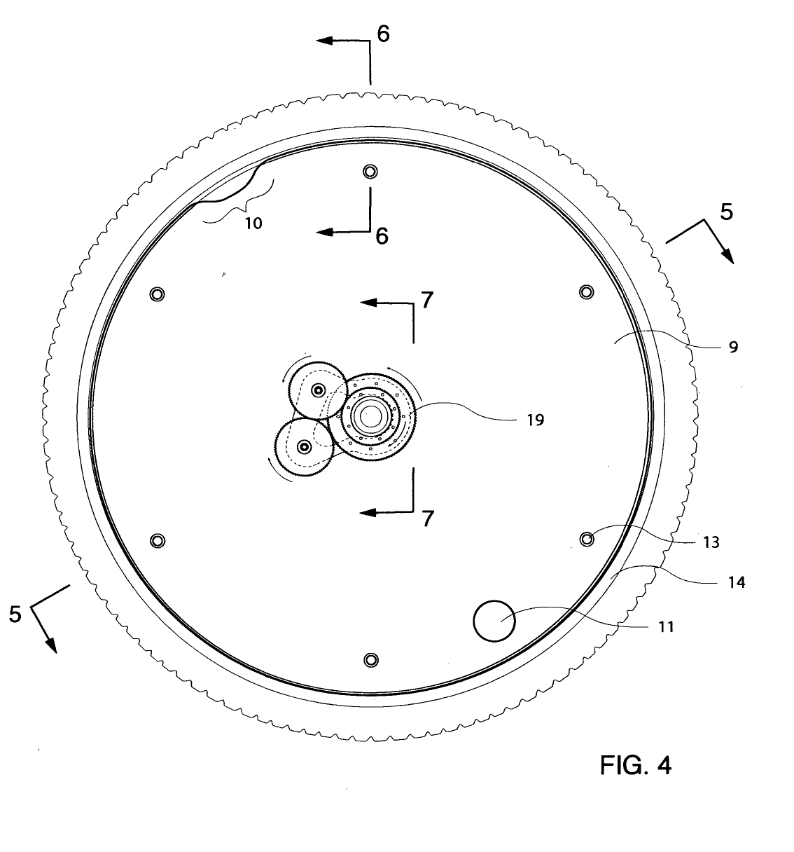

Following on to FIG. 4, the outer display disk has been removed and one sees the brains of the invention, a four geared reverse directional planetary gear assemblage. A plurality of mounting holes,13, and the valve stem access hole, 11 are also visible in this diagram, as well as the antitheft notch 10.

The stability of the outer disk and it's use on a bicycle is unique to the invention.

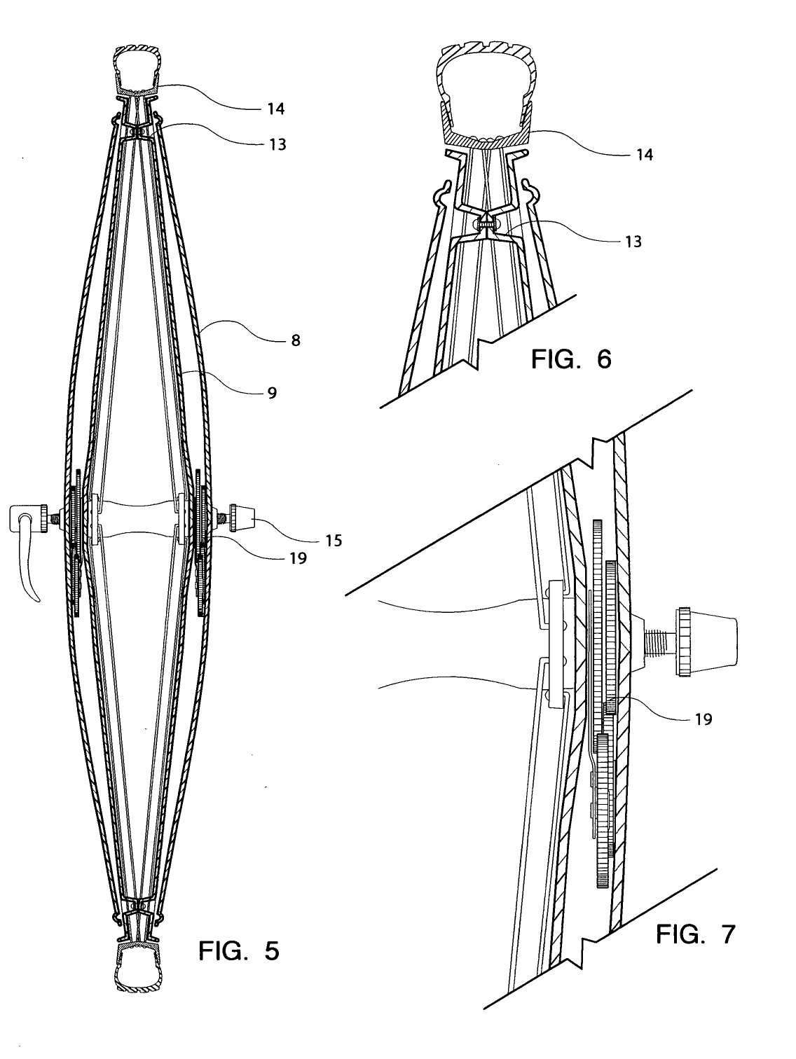

Referring to FIG. 5, showing one half of the invention, the assembly consists of five major components; the base disk thermoformed from a polystyrene or PVC type of sub-straight with a turned up leading edge and a center hole to except a bicycle wheel hub and skewer, 15. A plurality of recessed holes,13, to attach to a like assembly via sonic welding or mechanical fasteners. The gear assemblage enables the disk to turn freely with out wear or friction.

1. A pair of non-rotating circular display assemblies enclosing the spoked portion of a bicycle wheel comprising:
a pair of inner circular base disks having a raised outer circumference edge to abut a wheel rim, allowing the outer disk to nest within, utilizing a notched portion of said edge allowing access for a bicycle lock to cross through disks and bicycle rim, directly opposing a valve stem access hole inset from disk periphery;
said base disk having centrally located holes extending outward creating a rigidity, where through a bicycle wheel hub passes;
means for joining opposing base disks by aligning a plurality of protruding side of recessed holes between spoked portions of wheel attached at flat portions of recess via sonic weld or mechanical fastener;
a pair of outer convex disks having centrally located holes extending inward rigidity where through a bicycle wheel hub passes;
a thin, lightweight gear assemblage using various gear ratios to rotate said display disk at a desired speed backwards or synced to the forward rotation of the bicycle wheel to enable the display disk to remain upright and readable.
